(19) United States
(12) Patent Application Publication
(10) Pub. No.: US 2009/0300517 A1
(43) Pub. Date: Dec. 3, 2009

(54) PROVIDING USER CONTROL OF HISTORICAL MESSAGES IN ELECTRONIC MAIL CHAIN TO BE INCLUDED IN FORWARDED OR REPLIED ELECTRONIC MAIL MESSAGE

(75) Inventors: Kelii Justin Tsuyoshi Kaneshiro, Raleigh, NC (US); Arthur John Meloy, Raleigh, NC (US)

Correspondence Address: IBM CORP. (WSM);c/o WINSTEAD SECHREST & MINICK P.C., P.O. BOX 50784, DALLAS, TX, 75201, US

(73) Assignee: International Business Machines Corporation, Armonk, NY (US)

(21) Appl. No.: 12/131,083

(22) Filed: May 31, 2008

(51) Int. Cl. G06F 3/048; G06F 15/16

(52) U.S. Cl. 715/752

(57) ABSTRACT

A method, system and computer program product for controlling which historical messages are to be included in a forwarded or replied email message. The number of email messages in a chain of email messages contained in an email message is determined. A graphical user interface is generated that contains an option for the user to select one or more historical messages, or alternatively, an option to select a number of recent historical messages, in the chain of email messages to be included in the forwarded or replied email message. The selected historical messages in the chain of email messages to be included in the forwarded or received email message is received. The forwarded or replied email message is generated that includes the selected historical messages in the chain of email messages. By using this process, the recipient can save time in identifying the relevant details in the received email message.

### TECHNICAL FIELD

The present invention relates to sending electronic mail, and more particularly to providing the sender of an electronic mail message control over which historical messages are to be included in a forwarded or replied electronic mail message.

### BACKGROUND OF THE INVENTION

Electronic mail (hereinafter “email”) is widely used as a method of communication. People with email accounts (e.g., from an internet service provider) may easily compose and send an email message and attachments including text, graphics, audio, video, and/or multimedia components using a number of commercially available email management software applications. The message may be sent via a computer network (e.g., Internet) to a designated recipient or recipients.

The message typically includes data identifying the sender of the message, thereby facilitating facile reply by the recipient. In fact, typical email management software includes a reply function that allows the recipient to automatically address a reply message to the sender. It has become a common practice for the recipient of an email message to include some or all of the sender's text when replying to the email.

Email programs may also allow the original recipient of a message to forward the message to other parties. The forwarded message may include a message from the original recipient as well as the text generated by the original sender. Thus, as a message is passed to multiple recipients or between a recipient and a sender, the transmitted email message may progressively increase in size as each recipient adds to the message.

As a result, when a recipient receives an email message, the email message may include a long chain of email messages from other prior recipients. Often, the recipient, of such an email message, reads the entire chain of email messages in the email message to sift out the relevant details in order to understand the purpose of the email message. However, such a process is time consuming and inefficient. Further, it may be difficult to sift out the relevant details in a long chain of email messages.

### BRIEF SUMMARY OF THE INVENTION

In one embodiment of the present invention, a method for controlling which historical messages are to be included in a forwarded or a replied electronic mail message comprises receiving input to forward or reply to an electronic mail message containing a chain of electronic mail messages. The method further comprises determining a number of electronic mail messages in the chain of electronic mail messages. Additionally, the method comprises generating a graphical user interface containing an option to select one or more historical messages in the chain of electronic mail messages to be included in the forwarded or replied electronic mail message. Furthermore, the method comprises receiving input to include the selected one or more historical messages in the chain of electronic mail messages to be included in the forwarded or replied electronic mail message.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWING

A better understanding of the present invention can be obtained when the following detailed description is considered in conjunction with the following drawings, in which:

FIGS. 1A-C illustrate a long chain of email messages;

FIG. 2 is a hardware configuration of a computer system configured in accordance with an embodiment of the present invention;

FIG. 3 is a flowchart of a method for controlling which historical messages are to be included in a forwarded or replied email message;

FIG. 4 illustrates graphical user interface drop down menus demonstrating how the user may select the option to provide a consecutive number of recent historical messages in the forwarded or replied email message;

FIGS. 5A-B illustrate using the method of FIG. 3 to more precisely include the historical messages of interest so that the recipient can save time in identifying the relevant details in accordance with an embodiment of the present invention;

FIG. 6 is a flowchart of an alternative method for controlling which historical messages are to be included in a forwarded or replied email message; and

FIG. 7 illustrates a tree based graphical user interface that includes a summary for each historical message in the chain of email messages.

### DETAILED DESCRIPTION OF THE INVENTION

The present invention comprises a method, system and computer program product for controlling which historical messages are to be included in a forwarded or replied email message. In one embodiment of the present invention, the number of email messages in a chain of email messages contained in an email message is determined. In one embodiment, a graphical user interface is generated that contains an option for the user to select one or more historical messages in the chain of email messages to be included in the forwarded (referring to a received or a previously sent email message that is forwarded) or replied email message (referring to the received email message that is responded directly back to the sender). In another embodiment, a graphical user interface is generated that contains an option for the user to select a number of recent historical messages in the chain of email messages to be included in the forwarded or replied email message. The selected historical messages in the chain of email messages to be included in the forwarded or received email message is received. The forwarded or replied email message is generated that includes the selected historical messages in the chain of email messages. By allowing the user to select which particular historical messages in the chain of email messages or to select a particular number of recent historical messages in the chain of email messages to be included in the forwarded or replied email message, the recipient can save time in identifying the relevant details in the received email message.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

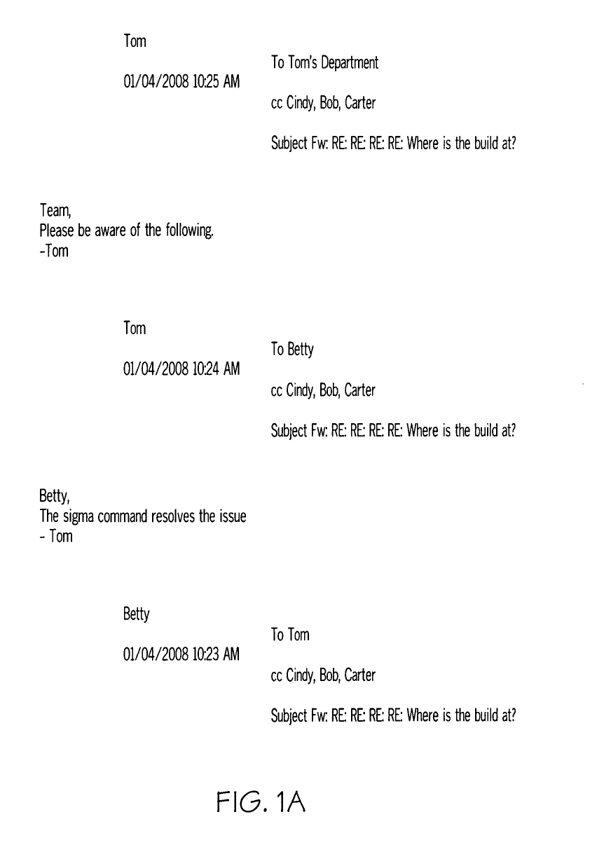

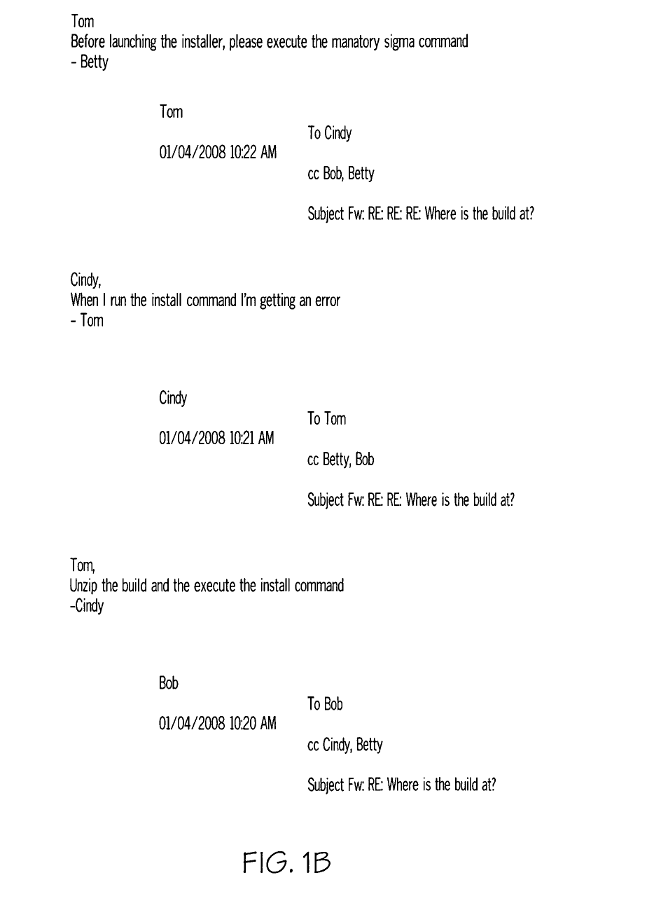

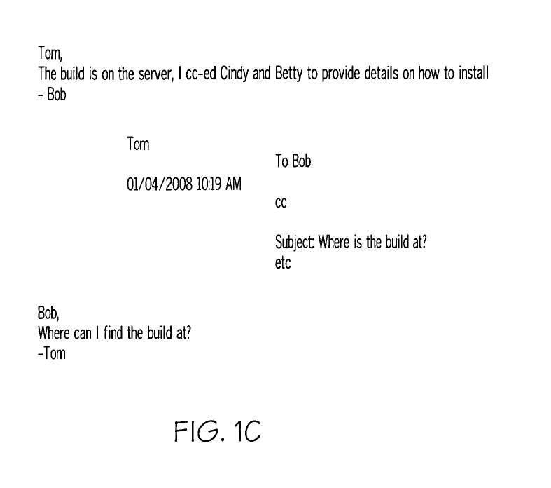

As discussed in the Background section, when a recipient receives an email message, the email message may include a long chain of email messages from other prior recipients. For example, referring to FIGS. 1A-C, FIGS. 1A-C illustrate a long chain of email messages. Often, the recipient, of such an email message, reads the entire chain of email messages in the email message to sift out the relevant details in order to understand the purpose of the email message. For example, referring to FIG. 1C, Tom sends Bob an email message on 01/04/2008 at 10:19 AM asking Bob where he can find the build at. As illustrated in FIGS. 1B-C, Bob responds to Tom, while cc'ing Betty and Cindy, at 10:20 AM that the build is on the server. Referring to FIG. 1B, Tom receives an additional email message from Cindy (Cindy cc's Bob and Betty) at 10:21 AM to unzip the build and execute the install command. Tom replies to Cindy's email message at 10:22 AM, cc'ing Bob and Betty, indicating that when he runs the install command, he is getting an error. As illustrated in FIGS. 1A-B, Betty emails Tom, and cc's Cindy, Bob and Carter, at 10:23 AM indicating that before launching the installer, the signal command needs to be executed. Referring to FIG. 1A, Tom sends an email message to Betty, cc'ing Cindy, Bob and Carter, at 10:24 AM indicating that the sigma command resolved the issue. Tom later forwards this stream of email messages to his department at 10:25 AM with a note to his team to be aware of the following. As clearly illustrated in FIGS. 1A-C, an individual on Tom's team who has no knowledge of the exchange of these email message will have to spend time in sifting through the chain of email messages to identify the relevant details in order to understand the received email message.

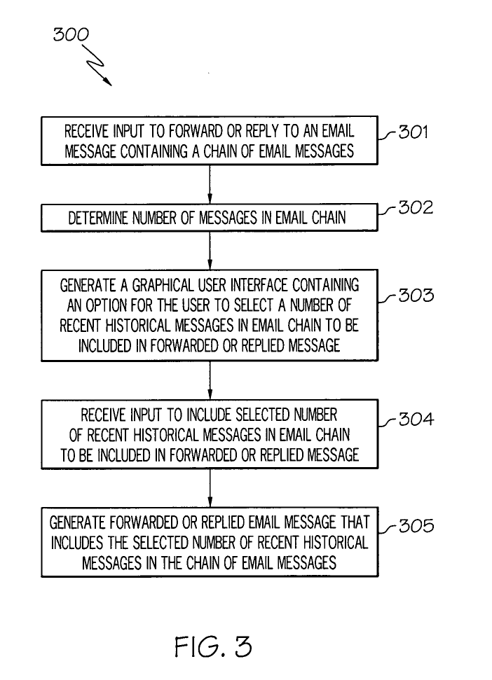

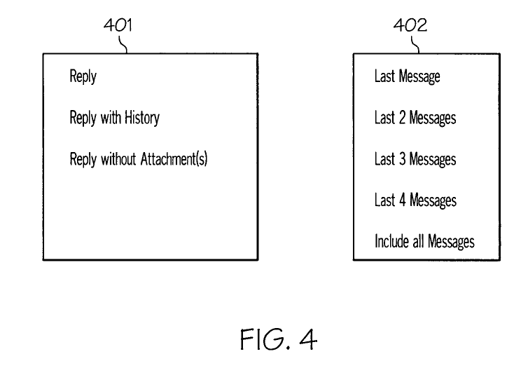

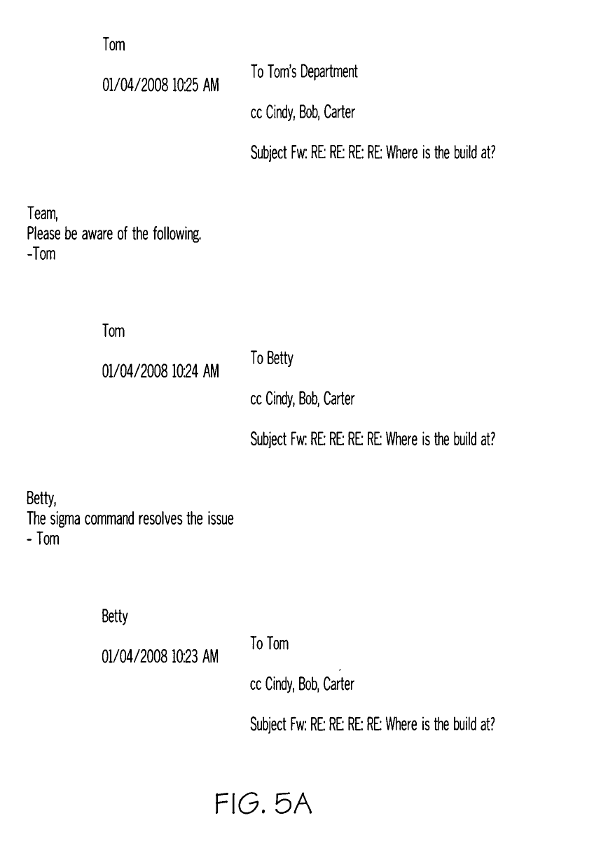

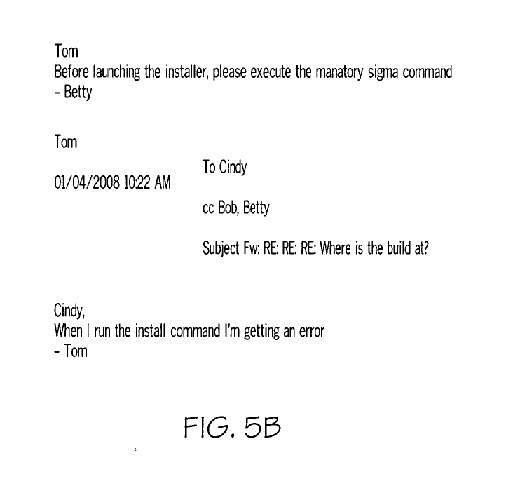

If, however, the sender of an email message could select a particular number of recent historical messages in a chain of email messages to be included in the forwarded or replied email message, then the recipient of the forwarded or replied email message could more quickly and efficiently sift through the selected historical messages to identify the relevant details. An embodiment of the present invention for allowing the sender of an email message to select a particular number of recent historical messages in the chain of email messages to be included in the forwarded or responded email message is discussed below in connection with FIGS. 3-4 and 5A-B. FIG. 3 is a flowchart of a method for controlling which historical messages are to be included in a forwarded or replied email message. FIG. 4 illustrates graphical user interface drop down menus that may be used by a user to select a number of recent historical messages in the chain of email messages to be included in the forwarded or responded email message. FIGS. 5A-B illustrate using the method of FIG. 3 to more precisely include the historical messages of interest (in contrast to the email message of FIGS. 1A-C) so that the recipient can save time in identifying the relevant details.

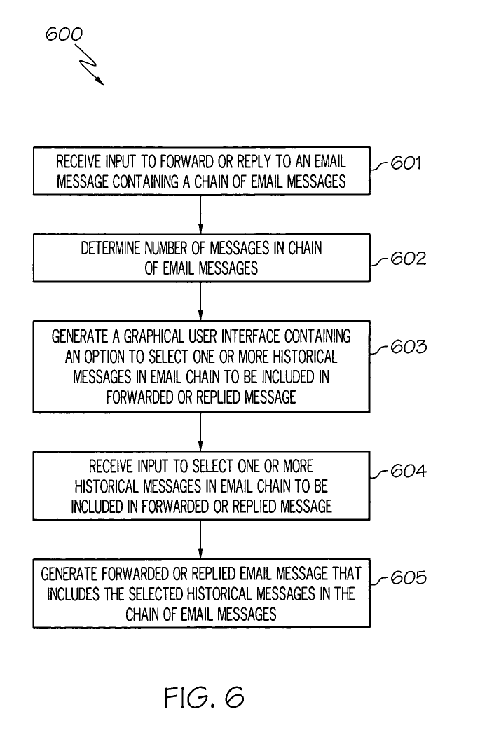

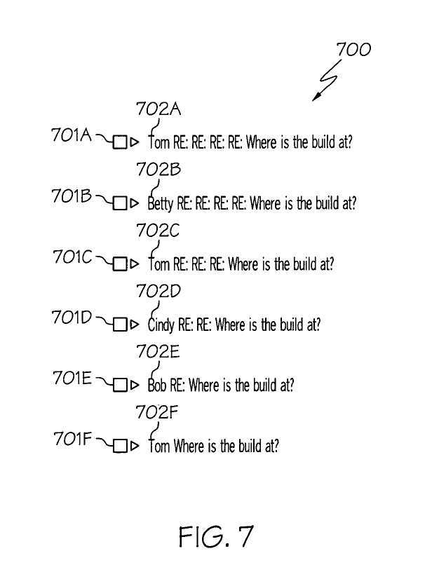

Furthermore, if the sender could select each particular historical message in the chain of email messages to be included in the forwarded or replied email message, then the recipient of the forwarded or replied email message could more quickly and efficiently sift through the selected historical messages to identify the relevant details. An embodiment of the present invention for allowing the sender of an email message to select particular historical messages in the chain of email messages to be included in the forwarded or responded email message is discussed below in connection with FIGS. 6-7. FIG. 6 is a flowchart of an alternative method for controlling which historical messages are to be included in a forwarded or replied email message. FIG. 7 illustrates a tree based graphical user interface for allowing the user to select which particular historical messages in the chain of email messages to be included in the forwarded or responded email message.

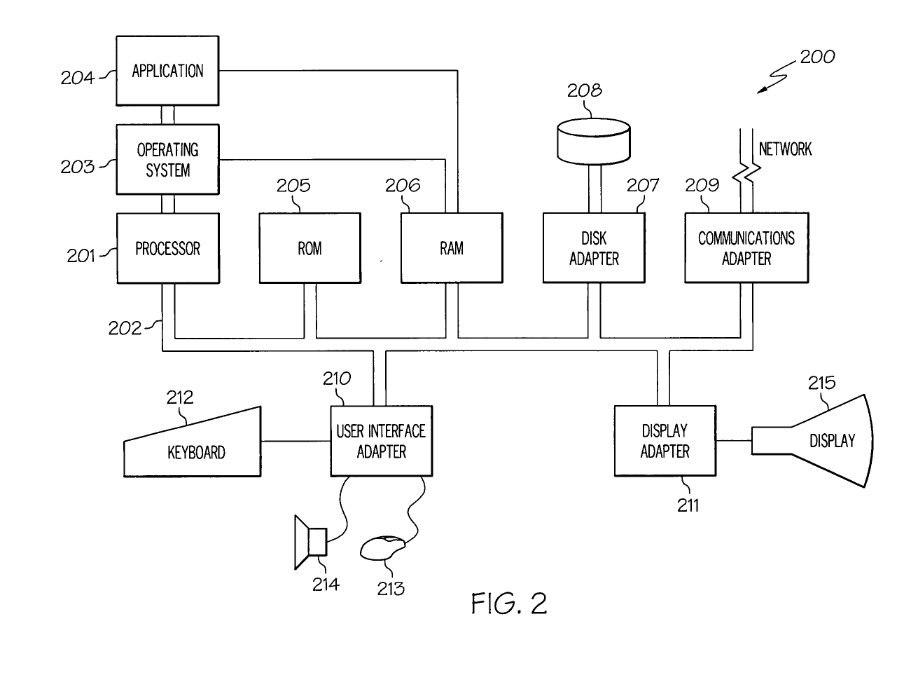

A description of a hardware configuration of a computer device for practicing the principles of the present invention is provided below in connection with FIG. 2.

### FIG. 2—Hardware Configuration of Computer Device

FIG. 2 illustrates an embodiment of a hardware configuration of computer system 200 which is representative of a hardware environment for practicing the present invention. Computer system 200 may have a processor 201 coupled to various other components by system bus 202. An operating system 203 may run on processor 201 and provide control and coordinate the functions of the various components of FIG. 2. An application 204 in accordance with the principles of the present invention may run in conjunction with operating system 203 and provide calls to operating system 203 where the calls implement the various functions or services to be performed by application 204. Application 204 may include, for example, a program for controlling which historical messages are to be included in a forwarded or replied email message as discussed further below in association with FIGS. 3 and 6.

Referring to FIG. 2, read-only memory (“ROM”) 205 may be coupled to system bus 202 and include a basic input/output system (“BIOS”) that controls certain basic functions of computer device 200. Random access memory (“RAM”) 206 and disk adapter 207 may also be coupled to system bus 202. It should be noted that software components including operating system 203 and application 204 may be loaded into RAM 206, which may be computer system's 200 main memory for execution. Disk adapter 207 may be an integrated drive electronics (“IDE”) adapter that communicates with a disk unit 208, e.g., disk drive. It is noted that the program for controlling which historical messages are to be included in a forwarded or replied email message, as discussed further below in association with FIGS. 3 and 6, may reside in disk unit 208 or in application 204.

Referring to FIG. 2, computer system 200 may further include a communications adapter 209 coupled to bus 202. Communications adapter 209 may interconnect bus 202 with an outside network (not shown) thereby allowing computer system 200 to communicate with other similar devices.

I/O devices may also be connected to computer system 200 via a user interface adapter 210 and a display adapter 211. Keyboard 212, mouse 213 and speaker 214 may all be interconnected to bus 202 through user interface adapter 210. Data may be inputted to computer system 200 through any of these devices. A display monitor 215 may be connected to system bus 202 by display adapter 211. In this manner, a user is capable of inputting to computer system 200 through keyboard 212 or mouse 213 and receiving output from computer system 200 via display 215 or speaker 214.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

A discussion of an embodiment for controlling which historical messages are to be included in a forwarded or replied email message is provided below in connection with FIG. 3.

FIG. 3—Method for Controlling which Historical Messages are to be Included in a Forwarded or Replied Email Message

FIG. 3 is a flowchart of a method 300 for controlling which historical messages are to be included in a forwarded or replied email message in accordance with an embodiment of the present invention.

Referring to FIG. 3, in conjunction with FIG. 2, in step 301, computer system 200 receives input to forward or reply to an email message, which includes a chain of email messages. For example, the email message to be forwarded or replied may include a chain of email messages as illustrated in FIGS. 1A-C. It is noted for clarity that an email message to be forwarded by the sender may include any email message that was received or previously sent by the sender. Further, it is noted for clarity that an email message to be replied may include any email message that was previously received by the sender.

In step 302, computer system 200 determines the number of historical email messages in the chain of email messages. For example, referring to FIGS. 1A-C, there are six (6) historical email messages when Betty received her email message from Tom at 10:24 AM on 01/04/2008.

In step 303, computer system 200 generates a graphical user interface containing an option for the user to select a number of recent historical messages in the chain of email messages to be included in the forwarded or replied email message. In one embodiment, the user provides the consecutive number of historical messages in the chain of email messages to be included in the forwarded or received email message. For example, referring to FIG. 4, FIG. 4 illustrates graphical user interface drop down menus on display 215 demonstrating how the user may select the option to provide a consecutive number of recent historical messages in the forwarded or replied email message in accordance with an embodiment of the present invention.

Referring to FIG. 4, drop down menu 401 on display 215 may include the options of simply replying to a received email message (indicated as “Reply” in drop down menu 401); replying to the received email message while providing the consecutive number of recent historical messages to be included in the replied email message (indicated as “Reply with History” in drop down menu 401); and replying to the received email message without any attachments (indicated as “Reply without Attachment(s)” in drop down menu 401). Upon the user selecting the option of “Reply with History” in drop down menu 401, drop down menu 402 may appear to the user on display 215.

Drop down menu 402 may include various options for the user to select, including, for example, including the last message (indicated as “Last Message” in drop down menu 402); including the last two messages (indicated as “Last 2 Messages” in drop down menu 402); including the last three messages (indicated as “Last 3 Messages” in drop down menu 402); including the last four messages (indicated as “Last 4 Messages” in drop down menu 402); and including all the messages (indicated as “Include All Messages” in drop down menu 402). Upon the user selecting the particular option, the number of consecutive historical messages will be included in the replied email message. It is noted that FIG. 4 may include other drop down menus or other graphical user interfaces. Further, FIG. 4 is used for illustration and is not to limit the scope of the present invention. For example, while FIG. 4 illustrates how a user may include historical messages in a replied email message, the principles presented in FIG. 4 may be used in including historical messages in a forwarded email message as discussed below.

For example, referring to FIGS. 1A-C, prior to Tom sending out the email message to Tom's department, Tom may select the option to forward the email sent out to Betty. Tom may then select via drop down menus similar to that shown in FIG. 4 to include the last three consecutive historical messages in the forwarded email message to Tom's department as illustrated in FIGS. 5A-B. Referring to FIGS. 5A-B, FIGS. 5A-B illustrate using the method of FIG. 3 to more precisely include the historical messages of interest (in contrast to the email message of FIGS. 1A-C) so that the recipient can save time in identifying the relevant details in accordance with an embodiment of the present invention.

Returning to FIG. 3, in conjunction with FIG. 2, in step 304, computer system 200 receives input to include a selected number of recent historical messages in the chain of email messages to be included in the forwarded or replied email message. In one embodiment, the selected number of recent historical messages refers to a consecutive number of recent historical messages.

In step 305, computer system 200 generates the forwarded or replied email message that includes the selected number of recent historical messages in the chain of email messages.

Method 300 may include other and/or additional steps that, for clarity, are not depicted. Further, method 300 may be executed in a different order presented and that the order presented in the discussion of FIG. 3 is illustrative. Additionally, certain steps in method 300 may be executed in a substantially simultaneous manner or may be omitted.

An alternative embodiment for controlling which historical messages are to be included in a forwarded or replied email message is provided below in connection with FIG. 6.

FIG. 6—Alternative Method for Controlling which Historical Messages are to be Included in a Forwarded or Replied Email Message

FIG. 6 is a flowchart of a method 600 for controlling which historical messages are to be included in a forwarded or replied email message in accordance with an embodiment of the present invention.

Referring to FIG. 6, in conjunction with FIG. 2, in step 601, computer system 200 receives input to forward or reply to an email message, which includes a chain of email messages. For example, the email message to be forwarded or replied may include a chain of email messages as illustrated in FIGS. 1A-C. It is noted for clarity that an email message to be forwarded by the sender may include any email message that was received or previously sent by the sender. Further, it is noted for clarity that an email message to be replied may include any email message that was previously received by the sender.

In step 602, computer system 200 determines the number of historical email messages in the chain of email messages. For example, referring to FIGS. 1A-C, there are six (6) historical email messages when Betty received her email message from Tom at 10:24 AM on 01/04/2008.

In step 603, computer system 200 generates a graphical user interface containing an option for the user to select one or more historical messages in the chain of email messages to be included in the forwarded or replied email message. For example, referring to FIG. 7, FIG. 7 illustrates a tree based graphical user interface 700 that includes a summary for each historical message in the chain of email messages. In one embodiment, a checkbox 701A-F is provided in connection with each summary 702A-F of email messages in the chain of email messages. Checkboxes 701A-F may collectively or individually be referred to as checkboxes 701 or checkbox 701, respectively. Summaries 702A-F may collectively or individually be referred to as summaries 702 or summary 702, respectively. In one embodiment, a user may select which historical message to be included in the forwarded or replied email message by selecting checkbox 701 associated with summary 702 of the historical message to be included in the forwarded or replied email message. In one embodiment, summary 702 of its associated historical message may include a subject line from the associated historical message. Tree based graphical user interface 700 may include summaries 702 (and consequently checkboxes 701) of any number of historical messages that may be contained in a chain of email messages. FIG. 7 is used for illustration and is not to limit the scope of the present invention to any one particular embodiment. For example, summary 702 may include language other than the subject line to summarize its associated historical message.

Returning to FIG. 6, in conjunction with FIG. 2, in step 604, computer system 200 receives input to include the selected historical messages in the chain of email messages to be included in the forwarded or replied email message.

In step 605, computer system 200 generates the forwarded or replied email message that includes the selected historical messages in the chain of email messages.

Method 600 may include other and/or additional steps that, for clarity, are not depicted. Further, method 600 may be executed in a different order presented and that the order presented in the discussion of FIG. 6 is illustrative. Additionally, certain steps in method 600 may be executed in a substantially simultaneous manner or may be omitted.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A computer program product embodied in a computer readable medium for controlling which historical messages are to be included in a forwarded or a replied electronic mail message, the computer program product comprising the programming instructions for:
receiving input to one of forward and reply to an electronic mail message containing a chain of historical electronic mail messages;
determining a number of electronic mail messages in said chain of historical electronic mail messages;
generating a graphical user interface containing an option to select one or more historical messages in said chain of historical electronic mail messages to be included in said one of forwarded and replied electronic mail message; and
receiving input selecting one or more historical messages in said chain of historical electronic mail messages to be included in said one of forwarded and replied electronic mail message.

2. The computer program product as recited in claim 1, wherein said graphical user interface comprises a tree based graphical user interface.

3. The computer program product as recited in claim 2, wherein said tree based graphical user interface comprises a summary for each historical message in said chain of historical electronic mail messages, wherein a checkbox is provided in connection with each summary of each historical message in said chain of historical electronic mail messages.

4. The computer program product as recited in claim 3, wherein a summary of an associated historical message comprises a subject line of said associated historical message.

5. The computer program product as recited in claim 1 further comprising the programming instructions for:
generating said one of forwarded and replied electronic mail message that includes said selected one or more historical messages in said chain of historical electronic mail messages.

6. A method for controlling which historical messages are to be included in a forwarded electronic mail message, the method comprising:
receiving input to forward to an electronic mail message containing a chain of historical electronic mail messages;
determining a number of electronic mail messages in said chain of historical electronic mail messages;
generating a graphical user interface containing an option to select one or more historical messages in said chain of historical electronic mail messages to be included in said forwarded electronic mail message; and
receiving input selecting one or more historical messages in said chain of historical electronic mail messages to be included in said forwarded electronic mail message.

7. The method as recited in claim 6, wherein said graphical user interface comprises a tree based graphical user interface.

8. The method as recited in claim 7, wherein said tree based graphical user interface comprises a summary for each historical message in said chain of historical electronic mail messages, wherein a checkbox is provided in connection with each summary of each historical message in said chain of historical electronic mail messages.

9. The method as recited in claim 8, wherein a summary of an associated historical message comprises a subject line of said associated historical message.

10. The method as recited in claim 6 further comprising:
generating said forwarded electronic mail message that includes said selected one or more historical messages in said chain of historical electronic mail messages.

11. A method for controlling which historical messages are to be included in a replied electronic mail message, the method comprising:
receiving input to reply to an electronic mail message containing a chain of historical electronic mail messages;
determining a number of electronic mail messages in said chain of historical electronic mail messages;
generating a graphical user interface containing an option to select one or more historical messages in said chain of historical electronic mail messages to be included in said replied electronic mail message; and
receiving input selecting one or more historical messages in said chain of historical electronic mail messages to be included in said replied electronic mail message.

12. The method as recited in claim 11, wherein said graphical user interface comprises a tree based graphical user interface.

13. The method as recited in claim 12, wherein said tree based graphical user interface comprises a summary for each historical message in said chain of historical electronic mail messages, wherein a checkbox is provided in connection with each summary of each historical message in said chain of historical electronic mail messages.

14. The method as recited in claim 13, wherein a summary of an associated historical message comprises a subject line of said associated historical message.

15. The method as recited in claim 11 further comprising:
generating said replied electronic mail message that includes said selected one or more historical messages in said chain of historical electronic mail messages.

16. A method for controlling which historical messages are to be included in a forwarded or a replied electronic mail message, the method comprising:
receiving input to one of forward and reply to an electronic mail message containing a chain of historical electronic mail messages;
determining a number of electronic mail messages in said chain of historical electronic mail messages;
generating a graphical user interface containing an option to select a number of recent historical messages in said chain of historical electronic mail messages to be included in said one of forwarded and replied electronic mail message; and
receiving input to include said selected number of recent historical messages in said chain of historical electronic mail messages to be included in said one of forwarded and replied electronic mail message.

17. The method as recited in claim 16, wherein said graphical user interface comprises a drop down menu indicating how many recent historical messages to include in said one of forwarded and replied electronic mail message.

18. The method as recited in claim 16 further comprising:
generating said one of forwarded and replied electronic mail message that includes said selected number of recent historical messages in said chain of historical electronic mail messages.

19. The method as recited in claim 16, wherein said number of recent historical messages in said chain of historical electronic mail messages to be provided in said one of forwarded and replied electronic mail message is a consecutive number of recent historical messages in said chain of historical electronic mail messages.
